(19) United States
(12) Patent Application Publication
(10) Pub. No.: US 2005/0134045 A1
(43) Pub. Date: Jun. 23, 2005

(54) Internally collared pipe joining system

(76) Inventors: Meera Mohan, New South Wales (AU); John DiSilvestri, Plant City, FL (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/742,505

(22) Filed: Dec. 18, 2003

(51) Int. Cl. F16L 19/00

(52) U.S. Cl. 285/370; 285/397

(57) ABSTRACT

A pipe assembly includes a first pipe section having a first end and a second end, a second pipe section having a first end and a second end, and an internal collar adapted for internal engagement with both the first end of the first pipe section and the second end of the second pipe section. The collar thereby locates the first and second pipe sections in end-to-end relationship at a joint to form a composite pipe. A method of forming a pipe assembly including the steps of: forming a first pipe section having a first end and a second end; forming a second pipe section having a first end and a second end; and forming an internal collar is provided. The method further includes the step of effecting simultaneous internal engagement of the collar with the first end of the first pipe section and the second end of the second pipe section; whereby the collar locates and retains the first and second pipe sections in end-to-end relationship to form a composite pipe.

### BACKGROUND OF THE INVENTION

1. Field of the Invention

The present invention relates generally to pipes and more particularly to a pipe assembly, pipe elements that make up the assembly, and an associated method of manufacturing a composite pipe. Certain embodiments of the invention have been developed primarily for use in connection with storm water and sewage pipes and will be described predominantly in terms of this application. It will be appreciated, however, that the invention is not limited to this particular field of use.

2. Description of the Related Art

The following discussion of the prior art is intended to place the invention in an appropriate technical context, and to enable the associated advantages to be more fully understood. It should be appreciated, however, that unless the context clearly dictates otherwise, references to the prior art should not be interpreted as admissions that such art forms part of common general knowledge in the field.

Composite pipes, pipelines and pipe networks are usually formed by interconnecting a multitude of discrete pipe sections. These pipe sections must be securely joined to prevent mechanical failure. The joints must also be effectively sealed to avoid leakage and excessive loss of fluid pressure along the pipe, as well as migration of fluid or soil into the pipe from outside. Sealing effectiveness and joint failure are often directly related to each other. For example, soil penetration into a pipeline as a result of ineffective sealing can lead to erosion of the underlying bedding, which in turn can lead to mechanical pipe failure as a consequence of localized stress concentration.

In known pipe systems, the sections to be connected are usually configured so that the outer diameter of each male end is smaller than the inner diameter of the corresponding female end of the adjoining section, so as to permit insertion of the male pipe end into the corresponding female pipe end. This provides a basic mechanical connection, typically referred to as a “socket and spigot”, or “bell and spigot” joint, which must then be secured and sealed.

One common form of pipe seal takes the form of an O-ring. This type of seal comprises an annular ring, normally of circular cross-sectional profile, formed from an elastomeric material such as rubber. It is typically retained within a circumferential retention groove formed around one end of a pipe section, normally the male end. The O-ring is sized to protrude radially beyond the surface of the pipe end surrounding the groove, so that upon insertion into a corresponding female end of an adjoining pipe section, the O-ring is resiliently compressed into the radial clearance space defined between the male and female pipe ends. In some instances, a circumferential shoulder or groove is also formed around the inner periphery of the female pipe end to facilitate captive retention of the O-ring in the optimal position and to resist withdrawal of the adjoining pipe sections, following installation. Other forms of compression seal having more flattened or special-purpose profiles are also known, but operate essentially on the same basic principles. Further known types of seals rely on differential pressure between the interior and exterior of the pipe to induce expansion pressure, as a substitute or a supplement to the pressure provided in response to resilient seal compression.

One known way of achieving the differential diameters between the male and female pipe ends involves the formation of a circumferential rebate around the outer wall of one pipe section and a corresponding rebate around the inner wall of a complementary pipe section, with the pipe sections otherwise having the same nominal internal diameters, and the same nominal but larger external diameters. One advantage with this particular form of bell and spigot joining system is that once the pipe sections are assembled in end-to-end relationship, the effective inner and outer diameters do not vary along the length of the resultant pipeline. There are, however, a number of significant disadvantages. Firstly, with common storm water pipe materials, a separate manufacturing process is usually required in order to form the external and internal rebates and the associated seal retention grooves on the respective male and female pipe ends. For example, in the case of fibre reinforced concrete (FRC) pipes, this is typically achieved by machining processes which add significantly to the production cost, and are further complicated by the production of significant quantities of dust. These processes also result in material wastage. Other forming processes can also be used, subject to material constraints, but almost inevitably result in additional cost and/or material wastage.

Perhaps more importantly, however, these rebates produce zones of significantly reduced wall thickness at both ends of each pipe section. Consequently, the pipe ends are potentially susceptible to failure in these weakened zones. This problem is exacerbated in a number of known pipe section designs, by the fact that sharp transitions in wall thickness between the machined ends and the main body can give rise to significant stress concentrations. Such pipes are particularly susceptible to failure in this mode during installation, when transient stress concentrations are typically at their highest levels.

In an attempt to ameliorate these disadvantages, it is also known to flare or bell the wall of one end of each pipe section to form a female end having an internal diameter marginally greater than the nominal outer diameter of the main pipe section. This technique potentially obviates the need for a separate forming or machining process, and reduces stress concentrations at the transition zones near the male and female ends. However, it gives rise to other disadvantages. Firstly, the process of flaring or belling is not without difficulties and can itself significantly increase production costs. Additionally, when laying a pipeline of this nature, it is necessary to remove additional material from the subsoil bed under each joint during the installation procedure, so as to accommodate the expanded outer diameter of the flared female end of each pipe section. This process significantly increases the time and cost of the installation procedure. Furthermore, if not done properly, for example if too much or too little bedding material is removed, additional stresses are introduced into the pipeline as a result of non-uniform bed support. In the case of buried pipelines, subsidence of the overlying earth following installation is also typically uneven, giving rise to the need for subsequent land filling by way of restoration.

As an alternative approach, it is also known to join adjacent pipe sections using an external collar adapted to surround the each pair of adjoining pipe ends, and captively retain the associated seals. This solution similarly avoids the need for significant machining of the pipe ends themselves, and also avoids the associated zones of weakness and stress concentration. However, because it results in an enlarged outer diameter of the pipeline at each joint, it suffers from essentially the same disadvantages as the pipe end flaring technique described above, in terms of the need for more complex and costly bed preparation, and the consequential problems inevitably associated with that.

A further disadvantage with this system arises because for a given nominal inner diameter, the wall thickness and hence the outer diameter will vary according to the material strength, pressure rating and other design parameters of the pipeline. Accordingly, across a range of pipes, it is necessary to provide a corresponding array of differently sized collars for each internal pipe size. In the context of large-scale production across a comprehensive product range, this adds significantly to the cost of manufacturing, as well as the cost and complexity of inventory control.

It is an object of the present invention to overcome or ameliorate one or more of these disadvantages of the prior art, or at least to provide a useful alternative.

### SUMMARY OF THE INVENTION

Accordingly, in a first aspect, the preferred embodiments of the present invention provide a pipe assembly including a first pipe section having a first end and a second end, a second pipe section having a first end and a second end, and an internal collar adapted for internal engagement with both the first end of the first pipe section and the second end of the second pipe section, the internal collar thereby locating the first and second pipe sections in end-to-end relationship at a joint to form a composite pipe.

The term “composite pipe ” as used herein is intended to denote a pipe assembly formed from at least two discrete pipe sections and one or more pipe joints connecting the respective pipe sections together. The term “pipe line” has essentially the same meaning, but is used herein to convey the sense of a larger number of pipe sections, in situ.

Preferably, the first and second pipe sections have substantially equal and substantially constant outer diameters, such that the external surface of the composite pipe is substantially flush across the joint. In one preferred embodiment, the first and second pipe sections are substantially identical to one another. It will be appreciated, however, that this need not be the case. In other embodiments, the internal collar in the form of a transitional fitting can be used to join pipes of substantially different internal and/or external diameter or cross-sectional profile.

In one preferred embodiment, the first and second pipe sections have substantially equal and substantially constant inner diameters, such that the internal collar protrudes radially inwardly into the internal flow path in the vicinity of each joint. In this embodiment, the pipe sections preferably have substantially constant inner and outer diameters throughout their lengths and one embodiment, take the form of hollow cylinders. The ends of the internal collar are preferably designed for reduced impact on hydraulic performance, having regard to factors such as pressure drop, laminar and turbulence flows. In one such embodiment, the ends of the internal collar are chamfered, to substantially reduce creation of turbulence in fluid flowing through the pipe in the vicinity of the joint.

Preferably also, the collar in this embodiment includes an outwardly extending circumferential locating flange positioned approximately midway along its length to define the position of maximum axial insertion of each end of the collar into the associated pipe end. The locating flange thereby ensures that upon installation, the collar is centrally positioned with respect to the adjoining pipe sections, with an approximately equal degree of insertion into each pipe end.

In another preferred embodiment, each end of each pipe section includes an internal rebate defining an end section of reduced inner diameter adapted to accommodate one end of the internal collar. In this embodiment, the internal collar is configured to be nestingly located within a composite internal groove defined by a first internal rebate formed in the first end of the first pipe section and a complementary second internal rebate formed in the second end of the second pipe section. In this way, the internal collar is substantially flush with the internal bore of the composite pipe. Consequently, in this embodiment, the ends need not be chamfered to reduce turbulence within the pipe, although the collar is nevertheless designed for optimum hydraulic performance in situ. A transition zone between each rebate and the adjacent main pipe section is preferably chamfered or radiused to substantially reduce stress concentrations. The external surface of the composite pipe is preferably again substantially flush across the joint. The internal collar in this embodiment may also be provided with a circumferential locating flange, although the primary functionality of this flange may alternatively or additionally be provided by the rebates, which, if optimally positioned and shaped, ensure central location of the collar. The locating flange may optionally be formed from, or coated with, a shock absorbent material, to absorb impact and substantially reduce the potential for damage to the associated pipe ends during installation.

Preferably, the pipe assembly includes a circumferential seal positioned radially between each end of the internal collar and the surrounding end of the associated pipe section, to seal the composite pipe at the join.

The composite pipe preferably includes a plurality of the first and second pipe sections, preferably being substantially identical in shape and configuration, and a corresponding plurality of internal collars and seals joining the respective pipe sections together, to form a pipeline.

Preferably, the collars are sized relative to the pipe sections to provide a predetermined radial clearance sufficient in conjunction with seal compression to accommodate a limited degree of rotation between adjoining pipe sections about any axis normal to the longitudinal pipe axis, thereby to enable progressive changes of direction in the pipeline without the need for supplementary bends, fittings or connecting elements. It should be appreciated, however, that in other embodiments, if such pipe rotation is not required and subject to the sealing arrangement employed, this radial clearance may be substantially reduced, or eliminated altogether.

In a second aspect, the preferred embodiments of the present invention provide an internal collar for use with a pipe assembly including a first pipe section having a first end and a second end and a second pipe section having a first end and a second end, the collar being configured for internal engagement with both the first end of the first pipe section and the second end of the second pipe section, the collar thereby in use locating the first and second pipe sections in end-to-end relationship to form a composite pipe.

In a third aspect, the preferred embodiments of the present invention provide a first pipe section having a first end and a second end, for use in a pipe assembly, the pipe assembly further including a second pipe section having a first end and a second end and an internal collar, the first end of the first pipe section being internally configured for connection to the second end of the second pipe section by substantially simultaneous internal engagement of the collar with the first end of the first pipe section and the second end of the second pipe section, the collar thereby in use locating the first and second pipe sections in end-to-end relationship to form a composite pipe. Preferably, the second pipe section is substantially identical to the first pipe section.

In a fourth aspect, the preferred embodiments of the present invention provide a method of forming a composite pipe, said method including the steps of:

forming a first pipe section having a first end and a second end;

forming a second pipe section having a first end and a second end;

forming an internal collar; and

effecting simultaneous internal engagement of the collar with the first end of the first pipe section and the second end of the second pipe section;

whereby the internal collar locates and retains the first and second pipe sections in end-to-end relationship to form a composite pipe.

Advantageously, the assembly and method of certain preferred embodiments of the invention can be used in connection with pipe fittings to enable pipes of different diameters to be joined together, or to enable pipes to be joined to ancillary components such as valves, manholes, pumped flanges, and the like.

### BRIEF DESCRIPTION OF THE DRAWINGS

FIG. 1 is a cross-sectional side elevation view showing a pipe assembly according to a first embodiment of the invention;

FIG. 2 is a cross-sectional side elevation view showing the internal collar from the pipe assembly of FIG. 1;

FIG. 3 is an end view of the collar shown in FIG. 2;

FIG. 4 is an enlarged cross-sectional view showing a pipe assembly according to a second embodiment of the invention, in which the locating rib is omitted from the collar;

FIG. 5 is an enlarged cross-sectional view showing a pipe assembly according to a third embodiment of the invention, in which the collar is located by internal rebates in the respective pipe ends;

FIG. 6 is an enlarged cross-sectional view showing a pipe assembly according to a fourth embodiment of the invention, which is similar to the embodiment shown in FIG. 5 but wherein the collar additionally incorporates a central locating rib;

FIG. 7 is an enlarged cross-sectional view showing a pipe assembly according to a fifth embodiment of the invention, in which the collar and associated rebates incorporate chamfered edges; and

FIG. 8 is an enlarged cutaway view showing a pipe assembly according to a variation on the third embodiment of the invention.

### DETAILED DESCRIPTION OF THE PREFERRED EMBODIMENT

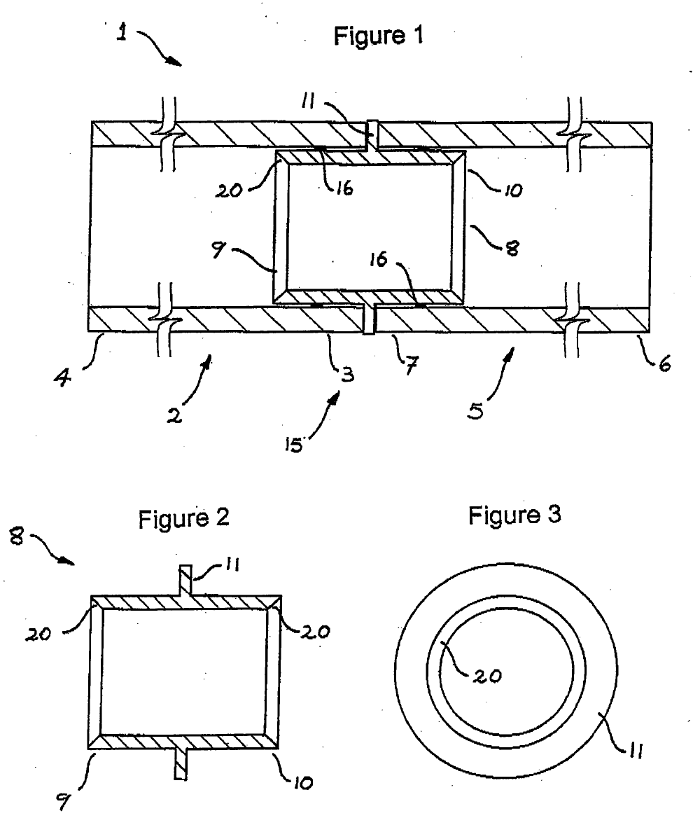

Referring initially to FIGS. 1 to 3, a preferred embodiment of the invention provides a pipe assembly 1 including a first pipe section 2 having a first end 3 and a second end 4, and a second pipe section 5 having a first end 6 and a second end 7. In the embodiment illustrated, the first and second pipe sections are substantially identical, although this need not be the case. The assembly further includes a collar 8, having a first end 9, a second end 10, and a circumferential locating flange 11 extending radially outwardly from a central section of the collar.

As best seen in FIG. 1, the first end 9 of the collar is adapted for internal engagement with the first end 3 of the first pipe section 2, while the second end 10 of the collar is adapted for substantially simultaneous internal engagement with the second end 7 of the second pipe section 5. By means of this engagement, the collar locates and retains the first and second pipe sections in end-to-end relationship at a joint 14, to form a composite pipe 15. The adjoining pipe ends abut the intermediate locating flange 11, to substantially prevent over-insertion and to ensure that the collar is centrally positioned across the joint in the assembled configuration.

Annular seals 16 are positioned in the radial clearance spaces defined between the respective ends of the internal collars and the corresponding pipe ends. These seals undergo radial compression upon assembly in the manner of an O-ring, V-ring or K-ring seal, to ensure effective sealing of the composite pipe at the joint. These seals, following resilient compression upon installation, also transmit a radially directed force from each end of the collar to the surrounding internal walls of the respective pipe sections, so as to positively locate and removably secure the pipe sections to the respective ends of the collar. If no seals are used, the collar and pipe ends may be configured for interference fit, to provide similar location and retention functionality. In some embodiments, these seals are retained within circumferential seal retention grooves (not shown) formed in each end of the collar, each pipe end, or both. These grooves help to prevent the respective seals from rolling or folding out of optimal alignment as each end of the collar is slid axially into the corresponding pipe end during the installation procedure. In some applications, it may also be possible to use a curable adhesive or sealant to join the collar to the respective pipe ends, as an alternative to a conventional compression seal.

Advantageously, because the pipe sections have substantially equal and constant outer diameters, the external surface of the composite pipe is substantially flush across the joint. Multiple pipe sections can thus be joined end-to-end with a corresponding series of internal collars to form a pipeline having a substantially smooth outer surface of effectively constant outer diameter. This greatly facilitates the process of bed preparation, substantially reduce localised stress concentrations at the joins due to uneven bed support, reduces the risk of uneven subsidence of overlying landfill, and enables the pipe to be used in pipe jacking installations.

In one embodiment, the collar protrudes radially inwardly into the pipe flow path in the vicinity of each joint, which substantially obviates the need for internal rebates or recesses in the pipe ends to accommodate the collar. Weakening of the pipe ends is therefore substantially avoided and the production process substantially simplified because the pipe sections have substantially constant wall thickness. This arrangement may be expected to introduction of turbulence into the fluid flowing through the pipe as a result of intrusion of the collar into the flow path. As such, the ends of the collar are therefore preferably formed with chamfers 20 so that the impact on flow rate and pressure drop across the pipeline is substantially minimised. However, surprisingly, preliminary analyses indicate that the adverse impact on flow rate and pressure loss across the pipeline due to the intermittent reduction in cross-sectional flow area caused by the collars is significantly less than initially anticipated. Moreover, preliminary analyses also indicate that the occurrence of “pooling” of liquid within the pipeline, behind the collars, at low flow rates is also less significant than anticipated.

The collar is preferably sized relative to the pipe sections to provide a predetermined radial clearance, sufficient in conjunction with seal compression, to accommodate a limited degree of rotation between each adjoining pair of pipe sections, about any axis normal to the longitudinal pipe axis. Advantageously, this longitudinal rotation enables progressive changes of direction in the pipeline without the need for supplementary connecting components such as junction boxes or elbow joints. In certain applications, and subject to other design constraints, the use of double seals or gaskets may also be employed to enhance rotation.

The collar may be formed from concrete, clay, fibre reinforced plastic (FRP), fibre reinforced concrete (FRC), metal, or any other suitable material, depending upon the nature of the fluid intended to be carried in the pipe, the pressure rating of the pipe, the material composition of the pipe sections, and other relevant design parameters. Generally, it is desirable to select a material with comparable or complementary properties such as deflection, load-bearing capacity, rate of thermal expansion and the like, as the associated pipe material.

The pipe is designed primarily as a storm water or pressure pipe and is provided in a range of sizes suitable for that purpose. The preferred range of internal pipe diameters includes about 12, 15, 18, 24, 30, 36 and 48 inch. For each internal diameter, a range of wall thicknesses or “classes”, and hence external diameters, is preferably provided. The optimum wall thickness or class will depend upon the desired pressure rating, burial depth and other relevant design criteria. By way of example only, for a 15 inch FRC pipe, the preferred wall thicknesses for the five standard classes would preferably range from about 20 mm to 40 mm. For a 36 inch FRC pipe, the preferred wall thicknesses for the five standard classes would preferably range from about 48 mm to 95 mm. More generally, the internal diameter is preferably in the range of about 10 to 50 inches and the wall thickness is preferably in the range of about 10 mm to 100 mm. However, it will be appreciated that the precise sizing can be tailored to set specific design requirements and will be depended in part upon the strength and grade of the materials used and other design factors.

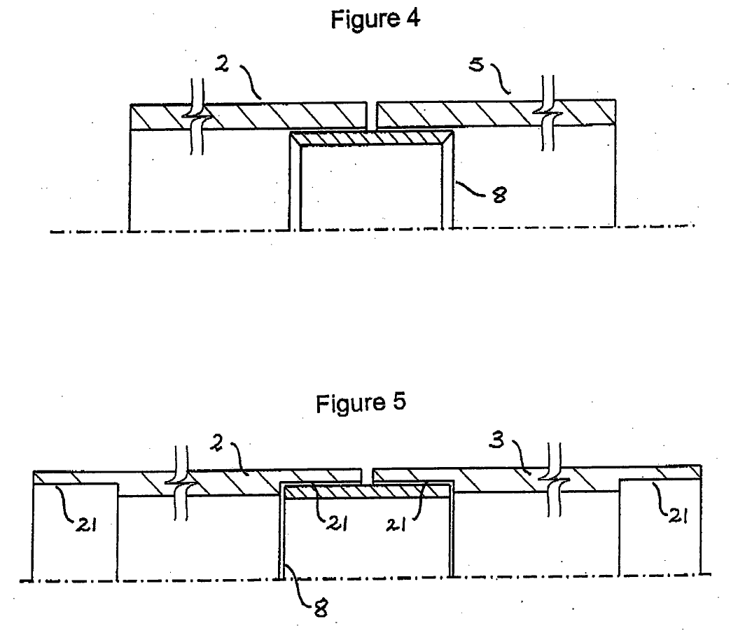

FIG. 4 illustrates another embodiment of the invention, in which the locating flange is omitted from the collar. Advantageously, this arrangement allows the pipe ends of adjoining sections to abut end-to-end. Ideally, this embodiment of the invention incorporates sealing retention grooves of the type previously described (not shown), to facilitate centering of the collar between the surrounding pipe ends.

FIG. 5 shows yet another embodiment of the invention, in which the collar is located by internal rebates 21, in the respective pipe ends. Each rebate 21 defines a section of reduced inner diameter in the associated pipe end, sized to accommodate a corresponding end of the internal collar 8. The collar is thereby configured to be nestingly located within a composite internal groove defined by the contiguous rebates in the adjacent ends of adjoining pipe sections. Because this composite groove effectively performs the axial locating function, this embodiment of the invention does not require a central locating flange. It will also be appreciated that because the collar is substantially flush with the internal bore of the composite pipe, the ends of the collar need not be chamfered to reduce turbulence within the pipe. This embodiment is therefore particularly appropriate for use in pipeline applications requiring a constant internal cross-sectional profile, or in other words a relatively smooth bore, whereby the collars do not protrude into the flow path or otherwise compromise the flow characteristics of the pipe. Preferably, in this embodiment, the overall length of the collar is marginally less than the sum of the lengths of the rebates in the adjoining pipe ends. This substantially avoids the possibility of the shoulders applying significant compressive load on the collar, which in certain circumstances can compromise sealing performance. Preferably, the collar in this embodiment should be able to “float” within the surrounding rebates, subjected only to radial pressure from the seals themselves.

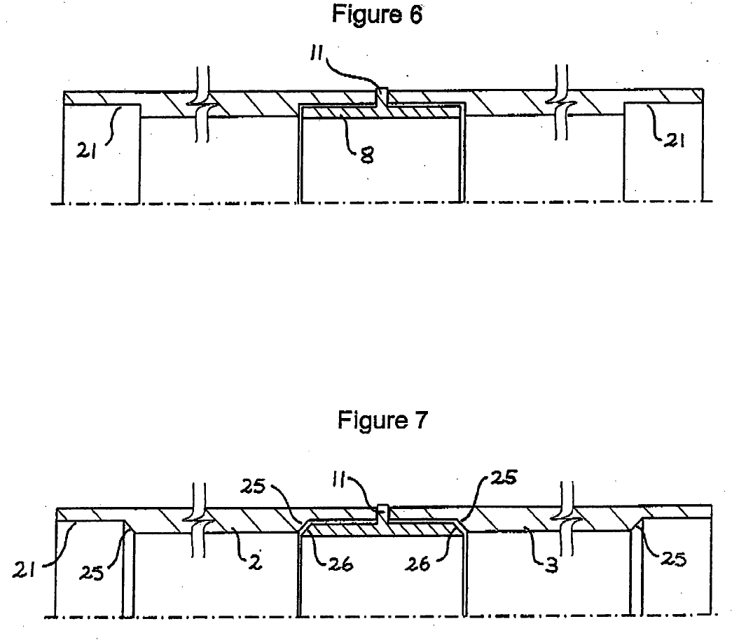

FIG. 6 shows yet another embodiment of the invention, which is similar to that shown in FIG. 5 but wherein the collar additionally incorporates a central locating flange. This flange operates in substantially the same manner as described in relation to the first embodiment of the invention, to centre the collar between the pipe sections and to substantially prevent over-insertion into one pipe end or the other. In this case, the arrangement as illustrated similarly maintains a substantially constant internal cross-sectional flow area within the pipeline.

FIG. 7 shows yet another embodiment of the invention, which is a variation on the version illustrated in FIG. 6. In this embodiment, the closed ends of the rebates incorporate respective chamfers 25 in the transition zones between the rebates and the adjacent main pipe sections. The ends of the collar incorporate complementary chamfers 26. These chamfers help to reduce stress concentrations in the transition zones, and thereby significantly reduce the probability of failure during installation, and in response to seal compression. It will be appreciated, however, that other stress reducing transitional geometries, such as radii, may alternatively be used. It will be noted that in this embodiment, the collar is provided with a circumferential locating flange 11 of the type previously described. It will be appreciated that in this instance, the primary functionality of the flange would to some extent be provided by the rebates, which are generally shaped and positioned to ensure central location of the collar with respect to the surrounding pipe ends. Again, however, each end of the collar is preferably slightly shorter than the surrounding rebate, so that the shoulders are not able to apply substantial axial loads to the collar.

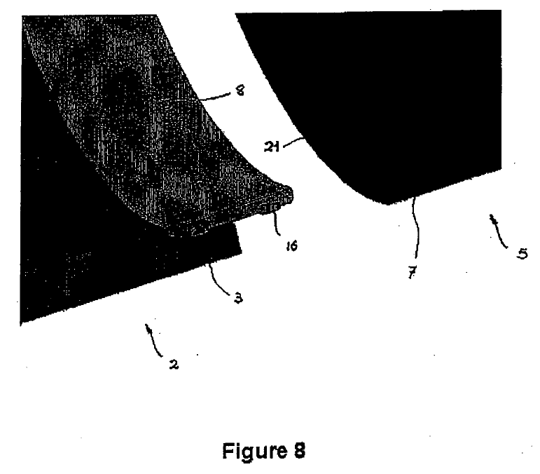

FIG. 8 shows a variation on the embodiment of the invention shown in FIG. 5, with the collar engaged with the first pipe section, but prior to engagement with the second pipe section. This embodiment shows radiused, rather than chamfered, transition zones between the rebates and the corresponding main pipe sections. It also shows an alternative sealing arrangement in which a pair of annular seals are located and captively retained within respective circumferential grooves recessed into the outer periphery of the collar, at its respective ends. The seals and associated grooves are shaped to reduce the insertion force required upon installation, to substantially optimise seal positioning, and to resist inadvertent pull-out after assembly.

These various embodiments of the present invention have been found to possess a number of significant and unexpected advantages. Firstly, the strength of the composite pipe at the joins has been found to be significantly increased relative to comparable forms of spigot and socket jointed pipes, even in those embodiments incorporating rebated ends of reduced wall thickness. Secondly, by obviating the need for flaring or belling the pipe ends, the outer diameter of the resultant pipeline is substantially constant. Consequently, no special bed preparation is required in order to accommodate expansion of the outer diameter of the pipe at the joins. This significantly facilitates the installation procedure and avoids the problem of additional stress and possible failure in the pipeline, as well as uneven subsidence of overlying soil, as a result of non-uniform bed support. Additionally, because a common collar size can be used, subject to design constraints, for each internal diameter of pipe, irrespective of wall thickness, the cost of production and the cost and complexity of inventory control are significantly reduced across a range of pipe sizes and pressure ratings. It has also been found, unexpectedly, that under similar load conditions, internal collars are subject to less sheer stress than comparable external collars. Furthermore, it has been found, surprisingly, that internal collars offer a greater degree of joint rotation and therefore better facilitate the incorporation of bends in composite pipelines, in comparison to external collars of comparable size and load-bearing capacity. In all these respects, the preferred embodiments of the present invention represent an unexpected, yet practical and commercially significant improvement, over the prior art.

Although the invention has been described with reference to specific examples, it will be appreciated by those skilled in the art that the invention may be embodied in many other forms.

1. A pipe assembly including a first pipe section having a first end and a second end, a second pipe section having a first end and a second end, and an internal collar adapted for internal engagement with both the first end of the first pipe section and the second end of the second pipe section, the internal collar thereby locating the first and second pipe sections in end-to-end relationship at a joint to form a composite pipe.

2. A pipe assembly according to claim 1, wherein the first and the second pipe sections have substantially equal and substantially constant outer diameters, such that the external surface of the composite pipe is substantially flush across the joint.

3. A pipe assembly according to claim 1, wherein the first and the second pipe sections are substantially identical to one another.

4. A pipe assembly according to claim 1, wherein the first and the second pipe sections are different in diameter or cross-sectional profile, wherein the internal collar functions as a transitional element.

5. A pipe assembly according to claim 1, wherein the first and the second pipe sections have substantially equal and substantially constant inner diameters, such that the internal collar protrudes radially inwardly into an internal flow path near the joint.

6. A pipe assembly according to claim 5, wherein the pipe sections have substantially constant inner and outer diameters throughout their respective lengths.

7. A pipe assembly according to claim 5, wherein the ends of the internal collar are chamfered to reduce creation of turbulence in fluid flowing through the pipe near the joint.

8. A pipe assembly according to claim 1, wherein the collar includes an outwardly extending circumferential locating flange defining a position of substantially maximum axial insertion of each end of the collar into the respective pipe end.

9. A pipe assembly according to claim 8, wherein the locating flange is positioned approximately midway along the length of the collar, thereby to ensure that upon installation, the collar is positioned generally centrally with respect to the adjoining pipe sections, with approximately equal degrees of insertion into the respective pipe ends.

10. A pipe assembly according to claim 8, wherein the locating flange comprises a shock absorbent material.

11. A pipe assembly according to claim 1, wherein at least one of the ends of at least one of the pipe sections includes an internal rebate defining an end section of reduced inner diameter, adapted to accommodate one end of the internal collar.

12. A pipe assembly according to claim 11, wherein each of the ends of each of the pipe sections includes a corresponding internal rebate defining a respective end section of reduced inner diameter adapted to accommodate one end of the internal collar.

13. A pipe assembly according to claim 12, wherein the internal collar is configured to be nestingly located within a composite internal groove defined by a first internal rebate formed adjacent the first end of the first pipe section and a complementary second internal rebate formed adjacent the second end of the second pipe section.

14. A pipe assembly according to claim 13, wherein the internal collar is substantially flush with an internal bore of the composite pipe.

15. A pipe assembly according to claim 11, wherein a transition zone between each of the rebates and an adjacent main pipe section is chamfered or radiused to reduce stress concentration.

16. A pipe assembly according to claim 1, wherein an external surface of the composite pipe is substantially flush across the joint.

17. A pipe assembly according to claim 1, including a circumferential seal positioned radially between each end of the ends of the internal collar and the surrounding end of the corresponding pipe section, adapted to seal the composite pipe at the joint.

18. A pipe assembly according to claim 17, wherein said seals are compression seals, configured upon installation to transmit a radially directed force from each end of the collar to the surrounding internal walls of the respective pipe sections, so as to positively locate and removably secure the pipe sections to the respective ends of the collar.

19. A pipe assembly according to claim 18, wherein said compression seal is selected from the group consisting of O-ring, a V-ring and K-ring seal.

20. A pipe assembly according to claim 1, wherein the composite pipe includes a plurality of the first and the second pipe sections, and a corresponding plurality of the internal collars joining the respective pipe sections together in situ, to form a pipeline.

21. A pipe assembly according to claim 1, wherein the collars are sized relative to the pipe sections to provide a predetermined radial clearance sufficient to accommodate a limited degree of rotation between adjoining pipe sections about any axis normal to a longitudinal pipe axis.

22. A pipe assembly according to claim 1, adapted for use as a storm water or pressure pipe, and having an internal diameter of at least about 12 inches.

23. A pipe assembly according to claim 22, being formed substantially from FRC, having an internal diameter of between about 10 and 50 inches, and having a wall thickness of between about 10 mm and 100 mm.

24. An internal collar for use with a pipe assembly as defined in claim 1, said collar being configured for substantially simultaneous internal engagement with both the first end of the first pipe section and the second end of the second pipe section, thereby in use locating the first and second pipe sections in end-to-end relationship to form the composite pipe.

25. A first pipe section for use in a pipe assembly as defined in claim 1, the first end of the first pipe section being internally configured for connection, in use, to the second end of the second pipe section by substantially simultaneous internal engagement of the collar with the with the first end of the first pipe section and the second end of the second pipe section, the collar thereby in use locating the first and second pipe sections in end-to-end relationship to form a composite pipe.

26. A method of forming a pipe assembly, said method including the steps of:
providing a first pipe section having a first end and a second end;
providing a second pipe section having a first end and a second end;
providing an internal collar; and
effecting substantially simultaneous internal engagement of the collar with the first end of the first pipe section and the second end of the second pipe section;
wherein the internal collar locates and retains the first and second pipe sections in end-to-end relationship to form a composite pipe.
